(19) United States
(12) Patent Application Publication
(10) Pub. No.: US 2019/0099316 A1
(43) Pub. Date: Apr. 4, 2019

(54) Neck Traction Device

(71) Applicant: Todd S. Pickman, Park City, UT (US)

(72) Inventor: Todd S. Pickman, Park City, UT (US)

(21) Appl. No.: 16/148,022

(22) Filed: Oct. 1, 2018

Related U.S. Application Data
(60) Provisional application No. 62/565,273, filed on Sep. 29, 2017.

(51) Int. Cl. A61H 1/02

(52) U.S. Cl. CPC A61H 1/0229; A61H 1/0296; A61H 2203/0443; A61H 2201/1611; A61H 2205/04; A61H 2201/0157

(57) ABSTRACT

A unique neck traction device is provided. The device presents a safe traction device that is easily operated by a single person without the risk of undue body strain. There is an adjustable locking mechanism that allows the person to relax while applying the necessary pressure for neck alignment and/or spinal adjustment. The device also utilizes force multipliers to safely and easily lift affected body parts.

### FIELD OF THE INVENTION

The invention pertains to a neck traction device that is useful for physical therapy and patient rehabilitation. The device is used to apply variable lifting forces on a body part by the patient without the need of assistance.

### BACKGROUND OF THE INVENTION

Traction is often prescribed for patients who need to be treated for neck or back pain or other areas of the body that may require muscle rehabilitation. It is generally recognized that application of traction to the neck region can help relieve pain in the neck, shoulders, arms, lower back, and even legs. Oftentimes, this pain is originally caused by a slipped cervical disc or other misalignment of the neck or spinal region. Injuries to other areas of the body are also know to transmit inferred pain and injury to a person's neck and spinal region.

Often, the apparatuses employed to apply traction to a person's neck or back are cumbersome and require assistance to setup and to operate. For example, U.S. Pat. No. 5,575,765 to Foster is one example of a traction device that is complex, cumbersome, and requires the assistance of additional persons to setup and to operate. The Foster device is typical of many such tractions devices that are useful for severe injury or misalignments but are impossible for the patient to use by himself or in a home-care environment. Many traction devices involve sleds or other such vehicles that support the patient and employs gravity as a force for applying the necessary pressure for realignment and stabilization of the affected area. U.S. Pat. No. 4,700,696 to Schoffstall is one such example.

In correcting neck injuries, it is important to allow the muscles of the neck to strengthen in an incremental fashion. At the beginning of the correction or rehabilitative phase, the pain experienced by the patient is often acute and limits the ability of the patient to relax and promote natural muscle healing. As treatment progresses, a patient is more able to participate in the necessary exercises and rehabilitative steps without acute pain. However, given the complicated nature of neck and back injuries, it is imperative that the patient be provided a traction device that is safe and easy to use so that inadvertent re-injury or stress of the affected area can be avoided. Furthermore, it is desirable that the traction device can be operated by a third person, as well as, by the patient himself. Self-reliance in rehabilitation is preferable to assisted therapy as the patient himself is better suited to accurately and immediately understand the effect of the traction forces and adjust accordingly.

There exists a need in the art for a traction therapy device that can safely be used by a patient without need for assistance from third parties. There further exists a need in the art for a traction device that provides incremental lifting forces while cushioning and protecting the affected area of the body. There also exists a need in the art for a traction device that is operable by a person with a limited range of extremity motion during the therapy session. There further exists a need in the art for a simple traction device that is lightweight, portable, and easy to setup and configure. Finally, there exists a need for a traction device that can be conveniently locked and unlocked in an adjustable therapy position by the patient himself.

All the aforementioned needs are solved by the present invention, which presents a safe solo-therapy traction device that is easily operated by an injured person at home without the risk of undue body strain. In addition, it is a feature of the present invention to provide a traction device with an adjustable locking mechanism that allows the person to relax while applying the necessary pressure for neck alignment and/or spinal adjustment. It is yet another feature of the present invention to provide a therapy traction device that allows the injured person to easily raise the affected body area without undue stress by utilizing multiple pulley forces in a safe and responsible manner that promotes healing.

### SUMMARY OF THE INVENTION

Xx

### BRIEF DESCRIPTION OF THE DRAWINGS

FIG. 1 illustrates a front perspective view of a neck traction device of the present invention.

FIG. 2 illustrates a side view of a patient using the neck traction device of the present invention.

It will be appreciated that the drawings are illustrative and not limiting of the scope of the invention, which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity.

### DETAILED DESCRIPTION OF THE INVENTION

Reference will now be made in detail to the presently preferred embodiments of the invention. There are also representative examples of the invention illustrated in the accompanying drawings. Throughout the following detailed description, the same reference numeral refers to the same elements in all figures.

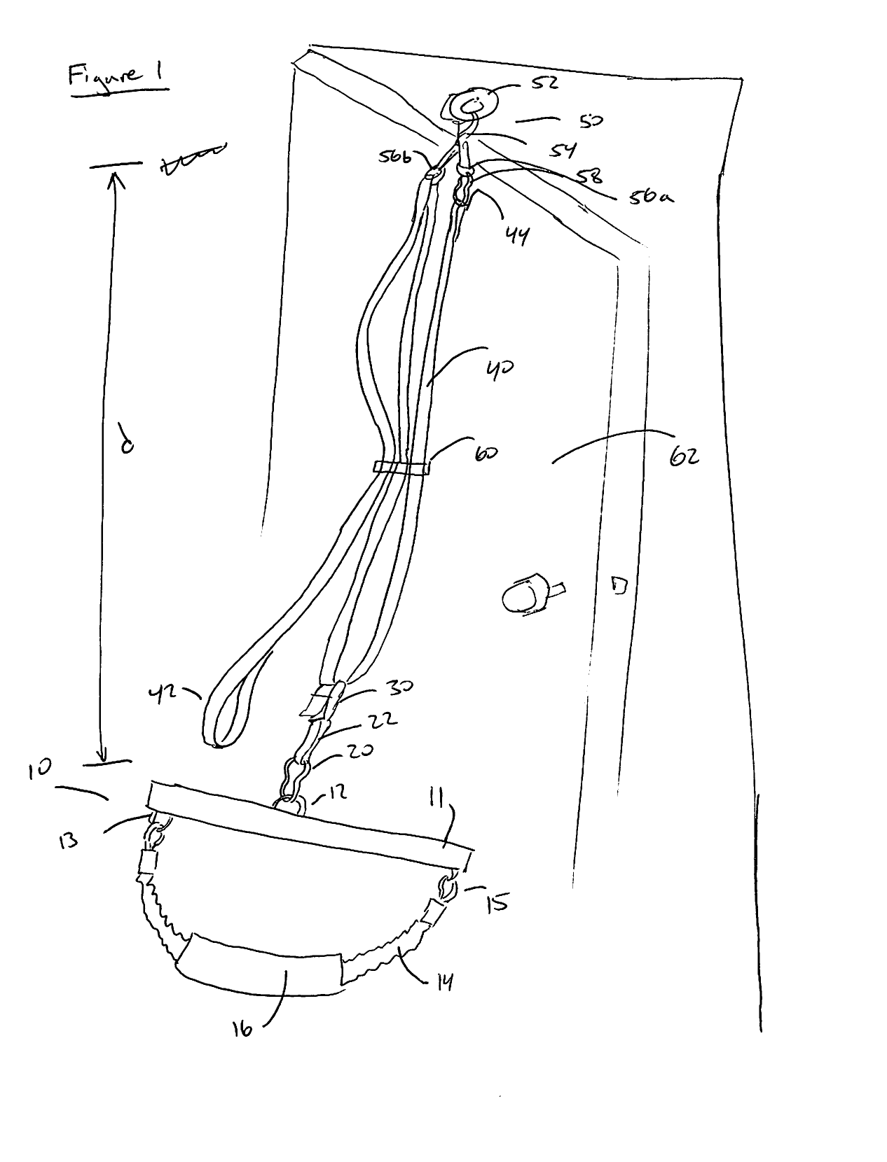

Now referring to the drawings, and first to FIG. 1, a traction device of the present invention is illustrated. The traction device comprises a support apparatus 10, which supports a lifting force to the patient's affected body area. Support apparatus 10 may also be configured to provide a stretchable cushioning action against the user's affected area to gently counteract the lifting force. There is a crossbar 11 that offers rigid structure to support apparatus 10. The crossbar may be formed of any type of rigid material, including flat metal, ceramic, plastic, and the like. In a preferred embodiment of the invention, crossbar 11 comprises a cylindrical steel bar, either hollow or solid, as that is more easily gripped by the user. Crossbar 11 may be encased with gripping tape, cloth, extruded foam, or other similar material that provides enhanced grip and may also absorb sweat from the user's hands. Lifting ring 12 is provided as a connection point between support apparatus 10 and the other parts of the traction device. If crossbar 11 is made of steel, lifting ring 12 may be a steel half-ring welded into position on the crossbar. Support apparatus 10 further comprises attachment points 13 at opposite ends of crossbar 11 for accommodating the connection of support member 14, described below. In one embodiment of the present invention, attachment points 13 comprise steel half-rings or d-rings welded to a steel crossbar 11.

Support apparatus 10 further comprises support member 14 having opposing ends that are connected to attachment points 13. Support member 14 can be any type of resilient material that can lift and support an affected area of a person's body. It is preferred that support member 14 comprise a stretchable material that provides a cushioning action during lifting of the affected body part. In a more preferred embodiment of the invention, support member 14 is a Slastix® safety sleeve elastic member. Slastix® devices are sheathed elastic members that provide both stretch and stretch limitations. The devices comes in varying degrees of elasticity, thus offering a range of elastic stretch properties that can be customized depending on patient need and the overall progress of the patient during the therapy regimen. In the initial stages of therapy, it may be preferable to utilize a soft elastic stretch, while in later stages of therapy, the patient might be more comfortable with Slastix® devices of more increasing resistance and firmer cushioning.

Support apparatus 10 may further comprise body support 16 for additional patient comfort. For example, when the traction device of the present invention is used to treat a patient with a neck injury, body support 16 would act to cushion and provide comfort to the neck region during the lifting action of the traction device. Body support 16 may be made of impression foam, cloth, pipe insulation, extruded foam, or any other type of cushioning material. Body support 16 may also have a protective covering design to absorb sweat from the affected area of the patient's body. Body support 16 may be either wrapped around support member 14 or support member 14 may be inserted into a hollow portion of the same. Releasable clips 15 may also be used to attach support member 14 to attachment points 13 of crossbar 11. An advantage of releasable clips 15 is that they allow simple interchange of varying support members with crossbar 11. However, the present invention also contemplates tying or otherwise permanently affixing support member 14 to crossbar 11. If support member 14 is permanently or semi-permanently affixed to crossbar 11, then it is important that support member 14 be of sufficient length to allow the user to insert his head or other affected body part into the gap between crossbar 11 and support member 14.

The traction device of the present invention further comprises central clip 20, press buckle 30, and adjustment strap 40. Central clip 20 may be a d-ring, carabineer, or similar type of releasable connection device. Although non-releasable devices are contemplated by the present invention, releasable devices are simpler to use in the manufacturing process and allow the traction device to be broken into component pieces for packaging, storage, or transport, and lend a modular assembly element to the invention. There may be an extension strap 22 that extends from central clip 20, connecting central clip 20 to press buckle 30. Either with or without extension strap 22, press buckle 30 is connected to central clip 20 so as to orient the buckle in a vertical alignment when the press buckle is conjoined with adjustment strap 40. Press buckle 30 is a commonly known component generally comprised of an offset cam, a lever, a spring, and opposing cam teeth whereby a strap may be threaded through the buckle for selective movement in one or two directions. When the lever of press buckle 30 is pressed, the strap may be freely moved in either direction through the buckle. When the lever of press buckle 30 is release, the spring engages and presses the strap against the cam teeth such that movement is allowed in one direction and stopped in the other direction. According to the present invention, press buckle 30 is placed close to crossbar 11 so that the patient can easily transition between holding crossbar 11 and adjusting press buckle 30 with his hands.

Adjustment strap 40 comprises strap handle 42 and a strap anchor 44. It is preferably made of a single continuous piece of strap with a length sufficient to accommodate a range of lifting positions when anchored to the top of a door, and when the user is either laying prone on the floor, laying in a bed, or sitting in a chair. As shown in FIG. 1, if d is the distance between the top of door 62 and lifting ring 12 then, in a preferred embodiment of the invention, adjustment strap 40 is of a length at least three times the distance d.

According to the present invention, there is also an anchor assembly 50 for attaching adjustment strap 40 to a support piece such as a door, window, or railing. In one embodiment of the invention, anchor assembly 50 comprises stopper 52, anchor strap 54, strap rings 56, and anchor carabineer 58. Stopper 52 may be a PVC pipe, ball, bundle, or other type of bulky device that cannot be pulled over a door and through a door jamb when the door is in a closed position. In one embodiment, stopper 52 is a PVC pipe with a protective foam covering. The foam covering is useful not only for protecting door 62 from scratches or marring during uses of the traction device but it may also protect the patient from injury from stopper 52 should the door be opened during the patient's use of the device. On one end, anchor strap 54 is threaded through or around stopper 52 and, on the other end, connected to adjustment strap 40 via strap rings 56 so as to provide secure attachment of strap 40 to anchor assembly 50. Anchor carabineer 58 may also be used to provide releasable functionality to anchor assembly 50 and adjustment strap 40.

General assembly of certain components of one embodiment of the present invention will now be explained. Strap anchor 44 of adjustment strap 40 is first connected via anchor carabineer 58 to anchor strap 54 and a first strap ring 56a. Adjustment strap 40 is then threaded down through press buckle 30, up through a second strap ring 56b, and then down again toward press buckle 30. Strap handle 42 is either made by folding the free end of adjustment strap 40 back onto itself and sewing or is attached to a separate handle via common connection techniques. Press buckle 30 is then attached to extension strap 22, which is then connected via central clip 20 to lifting ring 12 of crossbar 11. A Slastix® safety sleeve elastic of desired resistance is then fitted as support member 14 between attachment points 13 using releasable clips 15. In an optional embodiment, gathering clip 60 is wrapped around the main body of adjustment strap 40 to keep the strap bunched together and more manageable. It will be appreciated by those of skill in the art that there are additional assembly variations in keeping with the spirit and teachings of the present disclosure.

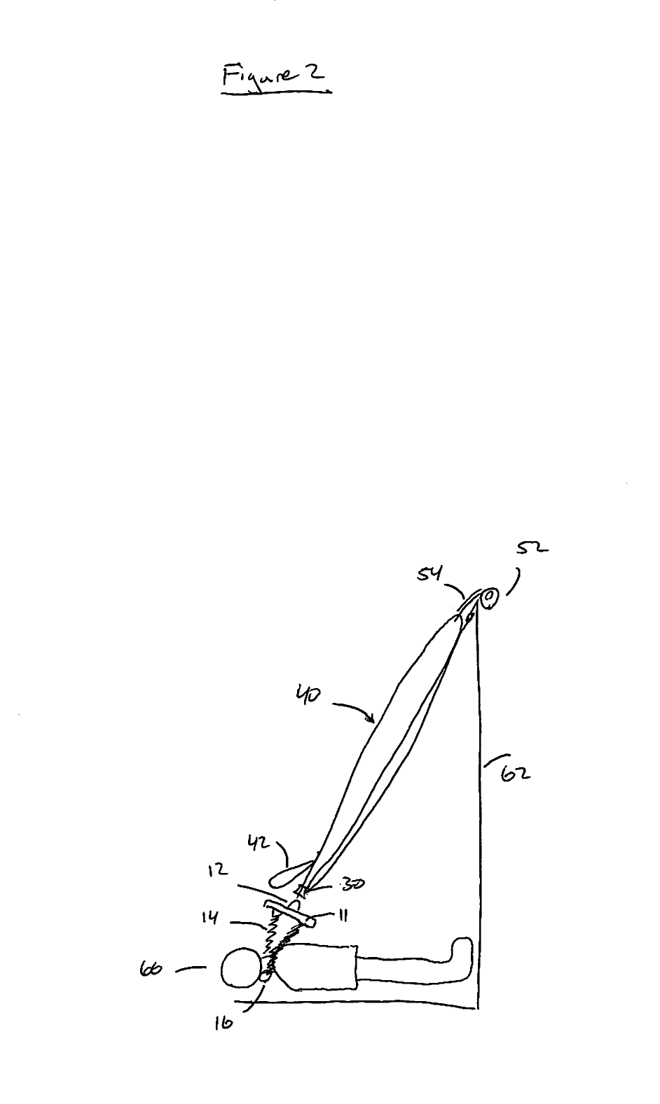

Use of the traction device of the present invention will now be explained in the sample case of a patient with a neck injury attaching the device to a door. Referring to FIG. 2, patient 66 will first lay anchor strap 54 across the top of door 62 so that stopper 52 falls on one side of the door and strap rings 56 fall on the other side of the door. The patient then closes door 62 to secure the traction device in a useable position. Patient 66 either sits on the floor or lays on the floor and places his head in the gap between crossbar 11 and support member 14. In a preferred embodiment, patient 66 also places body support 16 under his neck for additional comfort. With one hand on strap handle 42 and the other hand on the center of cross bar 11, patient 66 pulls down on adjusting strap 40 to trigger a 2:1 pulley-type lifting action of crossbar 11 and, by extension, support member 14. With assistance from the multiplying force lift of the pulley arrangement, patient 66 is able to more easily lift his injured body the desired distance necessary for effective therapy work. Once the desired lift is obtained, patient 66 ceases pulling on strap handle 42. The automatic locking of press buckle 30 prevents unwanted lowering of patient 66 back toward the floor. The patient is now free to place both hands on crossbar 11 and begin the therapy routine. Upward adjustment of the lift distance can easily be made by simply pulling down on strap handle 42. Downward adjustment either during the therapy routine or at the end of the session is accomplished by employing the dual action of gently releasing the strap through press buckle 30 while holding strap handle 42. In this manner, the patient may gently and easily provide lifting and gravitational release to the affected area of the body, in this example, the neck.

The advantages of the present invention include the locking mechanism of press buckle 30 allows for stationary applications where the patient 66 can easily relax and exercise the affected body area in a more natural state without tension, stress, and contortion usually associated with holding the body in a lifted position. Further, by using a stretchable member as support member 14, the present invention allows the user to maintain steady resistance to the affect body area. It is contemplated that various stretchable members for support member 14 can be employed depending on the weight of the patient and the desired amount of resistance. The present inventive traction device uniquely allows for self-locking traction on the neck while the user lays in a horizontal or prone position.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A portable rehabilitative traction device for a patient comprising:
a rigid crossbar;
a body support member suspended below said crossbar and an anchor located above said crossbar;
an adjustable positioning line connecting said crossbar to said anchor; and
a selectively unlockable position adjuster in communication with said positioning line between said crossbar and said anchor;
wherein said patient can increase upward tension between said anchor and said body support member by applying force to said positioning line.

2. The traction device of claim 1 wherein said body support member is stretchable.

3. The traction device of claim 2 further comprising a cushioning member central to said body support member.

4. The traction device of claim 3 wherein said body support member is releasably connectable to at least one end of said crossbar.

5. The traction device of claim 4 wherein said body support member is fully releasable from said crossbar.

6. The traction device of claim 1 wherein said position adjuster is a press buckle.

7. The traction device of claim 1 wherein said anchor further comprises a stopper.

8. The traction device of claim 7 wherein said anchor further comprises an anchor strap connecting said stopper with said positioning line.

9. The traction device of claim 1 wherein said positioning line further comprises a handle.

10. A portable rehabilitative traction device for a patient comprising:
a rigid crossbar;
a body support member suspended below said crossbar and an anchor located above said crossbar;
at least one relay point in connection with said anchor;
an adjustable positioning line connecting said crossbar to said anchor passing through said relay point; and
a selectively unlockable position adjuster in communication with said positioning line between said crossbar and said anchor;
wherein said patient can increase upward tension between said anchor and said body support member by applying force to said positioning line.

11. The traction device of claim 10 wherein said body support member is stretchable.

12. The traction device of claim 11 further comprising a cushioning member central to said body support member.

13. The traction device of claim 12 wherein said body support member is releasably connectable to at least one end of said crossbar.

14. The traction device of claim 134 wherein said body support member is fully releasable from said crossbar.

15. The traction device of claim 10 wherein said position adjuster is a press buckle.

16. The traction device of claim 10 wherein said anchor further comprises a stopper.

17. The traction device of claim 16 wherein said anchor further comprises an anchor strap connecting said stopper with said positioning line.

18. The traction device of claim 10 wherein said positioning line further comprises a handle.
